(19) United States
(12) Patent Application Publication
(10) Pub. No.: US 2020/0159159 A1
(43) Pub. Date: May 21, 2020

(54) IMAGE FORMING APPARATUS

(71) Applicant: CANON KABUSHIKI KAISHA, Tokyo (JP)

(72) Inventor: Shohei Okumura, Tokyo (JP)

(21) Appl. No.: 16/680,355

(22) Filed: Nov. 11, 2019

(30) Foreign Application Priority Data
Nov. 19, 2018 (JP) 2018-216858

(51) Int. Cl. G03G 21/00

(52) U.S. Cl. CPC G03G 21/0011

(57) ABSTRACT

A motor is controlled so that a carrier liquid is supplied from a developing roller to a photoconductive drum upon start of image forming, and a blade is moved to make contact with the photoconductive drum after a leading end of the carrier liquid supplied from the developing roller to the photoconductive drum reaches a cleaning position facing a blade.

### BACKGROUND OF THE INVENTION

### Field of the Invention

The present disclosure relates to an image forming apparatus that employs an electrophotographic method and forms an image using a liquid developer.

### Description of the Related Art

A conventionally known image forming apparatus forms an image by transferring a toner image formed on a photoconductive drum to a recording medium. Such an image forming apparatus generally employs a method for cleaning toner in which residual toner on the photoconductive drum that has not been transferred to a medium is cleaned transferred and remains by using a cleaning blade that makes contact with the photoconductive drum. In the above configuration, various malfunctions occur when a frictional force between the photoconductive drum and the cleaning blade is too strong. For example, a leading end of the cleaning blade occasionally oscillates (chattering occurs). In some cases, the leading end of the cleaning blade is chipped, and thus cleaning performance is degraded.

Japanese Patent Application Laid-Open No. 2004-191737 discusses a technique that supplies toner to a contact portion between a photoconductive drum and a cleaning blade when an image is not formed. The supplied toner functions as a lubricant to prevent the frictional force from becoming excessive, and thus the above-described malfunctions are eliminated.

In the meantime, in recent years, attention has been paid to increasing resolution using a liquid developing method.

Dry toner remains on the contact portion between the photoconductive drum and the cleaning blade even when an operation of the image forming apparatus is stopped after the toner is supplied to the contact portion between the photoconductive drum and the cleaning blade. Thus, when the operation is resumed, the dry toner still has the function as a lubricant immediately after the restart, and stability of cleaning performance is maintained. On the other hand, when the liquid developer having volatility is left to stand for a long period of time after the image forming apparatus is stopped, the liquid developer vaporizes, and thus does not function as a lubricant. If the image forming apparatus is restarted in such a case, a malfunction tends to occur due to an excessive frictional force between the photoconductive drum and the cleaning blade. Thus, the degradation of the cleaning performance becomes a concern.

### SUMMARY OF THE INVENTION

The present disclosure is, therefore, directed to decreasing degradation of a cleaning performance due to an excessive frictional force between a cleaning blade and a photoconductive drum at the restart of image forming in an image forming apparatus using a liquid developing method.

According to an aspect of the present disclosure, an image forming apparatus includes a photoconductive drum on which a latent image is to be formed, a developing device configured to develop the latent image to be formed on the photoconductive drum into a toner image, the developing device including a developing roller configured to hold a liquid developer containing toner and a carrier liquid, the developing roller being disposed to be movable to a first contact position where the developing roller makes contact with the photoconductive drum and a first separation position where the developing roller is separated from the photoconductive drum, a first motor configured to move the developing roller to the first contact position and the first separation position, a blade configured to clean the photoconductive drum, the blade being disposed to be movable to a second contact position where the blade makes contact with the photoconductive drum and a second separation position where the blade is separated from the photoconductive drum, a second motor configured to move the blade to the second contact position and the second separation position, and a control unit configured to control the first motor and the second motor. The control unit controls the first motor and the second motor so that the developing roller is moved from the first separation position to the first contact position upon start of image forming, and a blade is moved from the second separation position to the second contact position after a position of the photoconductive drum where the developing roller starts contacting reaches a cleaning position facing the blade.

Further features of the present disclosure will become apparent from the following description of exemplary embodiments with reference to the attached drawings.

### BRIEF DESCRIPTION OF THE DRAWINGS

FIG. 1 is a schematic cross sectional view illustrating a configuration of an image forming apparatus according to a first exemplary embodiment.

FIG. 2 is a cross sectional view illustrating a configuration of an image forming unit according to the first exemplary embodiment.

FIG. 3 is a block diagram illustrating a configuration of contact control according to the first exemplary embodiment.

FIG. 4 is a diagram illustrating a sequence flow of the contact control according to the first exemplary embodiment.

FIG. 5 is a timing chart of the contact control according to the first exemplary embodiment.

### DESCRIPTION OF THE EMBODIMENTS

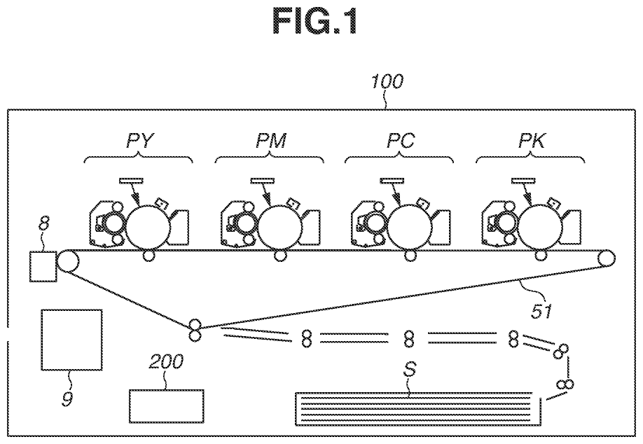

A first exemplary embodiment will be described. A schematic configuration of an image forming apparatus according to the present exemplary embodiment will be described with reference to FIG. 1.

### [Image Forming Apparatus]

An image forming apparatus 100 according to the present exemplary embodiment is a full-color printer employing a tandem intermediate transfer method in which four image forming units PY, PM, PC, and PK are disposed. The image forming units PY to PK are disposed to be evenly spaced in series in a moving direction of an intermediate transfer belt 51, and are associated with yellow (Y), magenta (M), cyan (C), and black (K) in developing devices 4, respectively.

The image forming apparatus 100 can output color images, which are formed based on image information sent from an external host device, not illustrated, such as a personal computer or an image reading apparatus which can communicate with the image forming apparatus 100 main body, to a recording medium S. Examples of the recording medium S are a cut sheet with average basis weight of 60 g/m² to 350 g/m² and overhead transparency (OHT) sheet. In a case where color images are output, the image forming apparatus 100 generates image signals obtained by color separation based on a print signal transmitted from the external host device, and causes the image forming units PY to PK to form toner images of respective colors based on the image signals. The image forming apparatus 100 then successively transfers, in a multiplexed manner, the respective color toner images formed by the image forming units PY to PK to the intermediate transfer belt 51, which moves in a predetermined direction, and collectively transfers the toner images transferred in the multiplexed manner from the intermediate transfer belt 51 to the recording medium S. The recording medium S, to which the toner images have been collectively transferred, is conveyed to a fixing device 9. The recording medium S, which has been conveyed to the fixing device 9, undergoes fixing processing, and the toner images are fixed to the recording medium S thereby. The recording medium S, to which the toner images have been fixed by the fixing device 9, is discharged out of the image forming apparatus 100, and a color image is output to the recording medium S.

### [Liquid Developer]

In the present exemplary embodiment, a liquid developer, which was obtained by dispersing particulate toner as a dispersoid in a carrier liquid as a dispersion medium, was used. As a carrier, a silicon solvent with volume resistivity of 1E+10 Ω·cm or more, hydrocarbon, or ethers can be used. The toner is a resin particle that contains any one of yellow, magenta, cyan, and black pigments, and has a center particle diameter of 1 μm. A usable liquid developer has toner density which has been adjusted to a predetermined value ranging from 0.1 wt % to 20 wt %, and viscosity ranging from 0.5 cP to 100 cP. Further, the toner used in the present exemplary embodiment is negatively charged toner. Note that a liquid developer is not limited to the described liquid developer as long as the physical property values are within the above-described ranges, and thus a liquid developer having an ultraviolet curing ability may be used.

### [Image Forming Units]

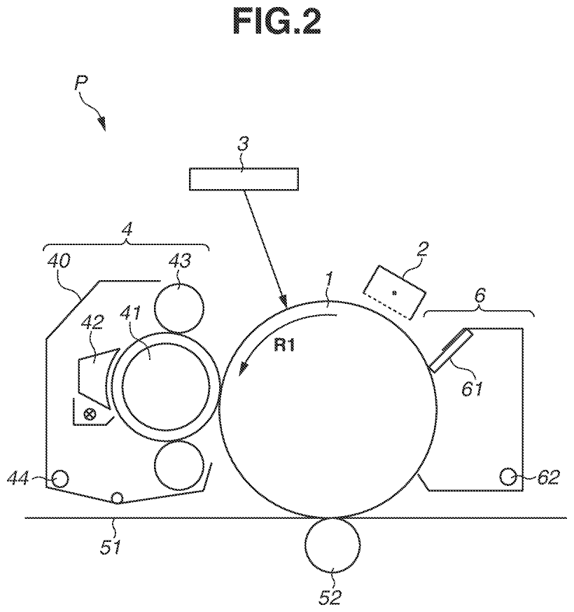

The image forming units PY to PK that form respective color images will be described with reference to FIG. 2. The image forming units PY to PK have identical configuration except for different toner colors to be used in developing devices 4Y to 4K, and thus trailing signs Y, M, C, and K which are given for discriminating the image forming units PY to PK will be omitted in the description where the discrimination is not needed.

As illustrated in FIG. 2, in the image forming unit P, a charging device 2, an exposing device 3, the developing device 4, and a drum cleaning device 6 are disposed around a photoconductive drum 1. The photoconductive drum 1 is a photoconductor in which an amorphous silicon photoconductive layer is formed on an outer peripheral surface of an aluminum cylinder, but an organic photoconductor can be also used. The photoconductive drum 1 is rotated by a drum drive motor at a process speed which is a peripheral velocity of, for example, 500 mm/sec in a direction of arrow RI in the drawing. The photoconductive drum 1, a developing roller 41, and the intermediate transfer belt 51 are driven at the identical process speed.

The charging device 2 is a scorotron corona charger, and charges a surface of the photoconductive drum 1 so that uniform dark portion potential with negative polarity (for example, −500 V) is obtained. A charging high-voltage power supply 21 applies a direct current voltage to a tungsten or stainless discharge wire which has been shielded by metal such as aluminum and has a diameter ranging from about 50 μm to 100 μm, and thus the corona charger charges the surface of the photoconductive drum 1.

The photoconductive drum 1, which has been charged by the charging device 2, undergoes image exposure by the exposing device 3. The exposing device 3 generates a laser beam, obtained by performing on-off modulation on scanning line image data obtained by developing respective separated color images, from a laser light emitting element. Then, a rotary mirror is used to scan the laser beam, and an electrostatic latent image of a target image is formed on the charged surface of the photoconductive drum 1. Potential on a portion which has been irradiated with the laser by laser scanning exposure is lower than the potential before the irradiation, and electrostatic latent images corresponding to image information are formed. In the present exemplary embodiment, the potential on the exposed portion was −100 V.

The electrostatic latent images formed on the photoconductive drum 1 are developed by the developing device 4 using a liquid developer. As illustrated in FIG. 2, the developing device 4 includes a developer container 40 that configures a casing, the developing roller 41, a developing electrode 42, and a squeeze roller 43.

The developer container 40 holds a liquid developer containing monochrome toner and a carrier liquid. The developer container 40 is open, as illustrated in FIG. 2, at a part facing the photoconductive drum 1. The developing roller 41 is rotatably disposed to be partially exposed from the opening. The developing roller 41 holds a liquid developer containing toner and a carrier liquid. The developing roller 41, which has a cylindrical shape, is rotated in one direction on a surface facing the photoconductive drum 1. Further, the developing roller 41 develops the latent images, which have been formed on the photoconductive drum 1, at a developing position facing the photoconductive drum 1. The developing roller 41 is a rubber roller having a rubber layer on a surface thereof. The rubber roller reduces damage of the photoconductive drum 1. Toner density and a liquid film thickness of the liquid developer supplied to a supply tray from a mixer, not illustrated, by a liquid developer conveyance unit 202, are adjusted by the developing electrode 42 and the squeeze roller 43. Thereafter, the liquid developer is conveyed to a developing unit where the developing roller 41 faces the photoconductive drum 1 by rotation of the developing roller 41.

The developing device 4 is disposed to be rotatable about a turning shaft 44 by a first motor serving as a developing device contact-and-separation unit 46. The turning of the developing device 4 enables the developing roller 41 to move between a contact position where contact with the photoconductive drum 1 is made to supply the liquid developer and a separation position where separation from the photoconductive drum 1 is made not to supply the liquid developer. The developing device contact-and-separation unit 46 can prevent the developing roller 41 from constantly making contact with the photoconductive drum 1 and thus the developing roller 41 from being deformed (so-called, C set).

A developing high-voltage power supply 45 applies a developing high voltage of, for example, −300 V to the developing roller 41. At the contact position, toner adheres to the electrostatic latent images formed on the photoconductive drum 1 at the developing unit, and thus the electrostatic latent images are developed into toner images.

The respective color toner images formed on the photoconductive drum 1 are primarily transferred onto the intermediate transfer belt 51, and are sequentially superimposed on each other. A primary transfer unit is configured in such a manner that a primary transfer roller 52 is disposed on an inner peripheral surface side of the intermediate transfer belt 51 to make contact with the photoconductive drum 1 via the intermediate transfer belt 51. A primary transfer high-voltage power supply 53 applies a primary transfer high voltage (for example, +800 V) to the primary transfer roller 52. Thus the toner images are primarily transferred from the photoconductive drum 1 to the intermediate transfer belt 51.

In the primary transfer unit, residual toner on the photoconductive drum 1 which has not been transferred to the intermediate transfer belt 51d, is removed from the photoconductive drum 1 by the drum cleaning device 6 at a cleaning position. Further, the potential of the photoconductive drum 1 is decreased to predetermined potential by a discharging device, not illustrated, and thus the apparatus prepares for subsequent image forming processing.

All the toner images, which have been primarily transferred to the intermediate transfer belt 51 in the superimposed manner, are secondarily transferred to the recording medium S at a time. A secondary transfer unit is configured in such a manner that a secondary transfer outer roller 72 is disposed to make contact with a secondary transfer inner roller 71 that supports the intermediate transfer belt 51 from the inside in a tensioned manner via the intermediate transfer belt 51. The toner images on the intermediate transfer belt 51 are conveyed to the secondary transfer unit in timing for conveyance, a secondary transfer high voltage (for example, +2000 V) is applied to the secondary transfer outer roller 72. Thus the toner images are secondarily transferred from the intermediate transfer belt 51 to the recording medium S.

Toner which remains on the intermediate transfer belt 51 after the secondary transfer is collected by a belt cleaning device 8.

The recording medium S, to which the toner images have been secondarily transferred, is conveyed to the fixing device 9 to be heated and pressed. Accordingly, the toner images are fixed to the recording medium S. In a case where an ultraviolet curable liquid developer is used, fixing processing may be executed by ultraviolet irradiation instead of thermal compression.

### [Drum Cleaning Device]

A configuration and an operation of a drum cleaning device according to the present exemplary embodiment will be described below.

A drum cleaning device 6 includes a blade 61 and a scooping sheet. The drum cleaning device 6 is disposed to be rotatable about a turning shaft 62 by a second motor serving as a drum cleaning device contact-and-separation unit 63. The drum cleaning device 6 is turned to be movable between a contact position where the blade 61 makes contact with the photoconductive drum 1 to remove toner and a separation position where the blade 61 is separated from the photoconductive drum 1.

The blade 61 makes contact with the photoconductive drum 1 at the contact position to form a cleaning unit. The cleaning unit mechanically scrapes primary transfer residual toner off to clean the photoconductive drum 1. The blade 61 is formed in a plate shape with thickness of 3 mm by using, for example, an urethan rubber material with JIS-A rubber hardness of 80°. A blade 70 makes contact with the photoconductive drum 1 at an angle of about 25° in a counter direction to invade the drum surface with a free length of the blade 70 being 10 mm and an invasion amount being about 0.5 mm, for example.

### [Control Unit]

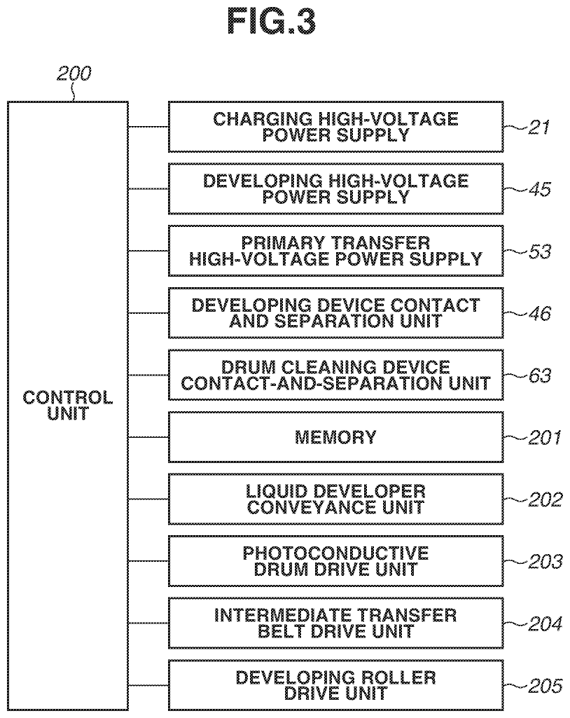

The image forming apparatus 100 according to the present exemplary embodiment includes a control unit 200. The control unit 200 will be described with reference to FIG. 3. Note that the control unit 200 is connected with various devices such as motors and power supplies that operate the image forming apparatus 100 aside from illustrated devices. However, illustration and description about such various devices are omitted because they are not main ideas herein.

The control unit 200, which variously controls the image forming apparatus 100, includes a central processing unit (CPU), not illustrated. The control unit 200 is connected with a memory 201, such as a read only memory (ROM), a random access memory (RAM), or a hard disk device, as a storage unit. The memory 201 stores various programs and data for controlling the image forming apparatus 100. The control unit 200 executes an image forming job stored in the memory 201 to cause the image forming apparatus 100 to form an image. In the present exemplary embodiment, at the start of the image forming job, the control unit 200 can cause the blade 61 and the developing roller 41 to make contact with the photoconductive drum 1. The contact control will be described below. The memory 201 temporarily stores calculation results obtained by executing various control programs.

The image forming job is a set of operating steps including the start of the image forming through the end of the image forming based on a print signal for forming an image on the recording medium S. That is, the image forming job is the set of steps including the start of a preliminary operation (hereinafter, a pre-rotation) necessary for the image forming, an image forming step, and the end of a preliminary operation (hereinafter, post rotation) necessary for ending the image forming. Specifically, the image forming job means the start of the pre-rotation after reception of the print signal through the end of the post rotation, and includes an image forming period and a sheet-to-sheet interval.

The control unit 200 is connected with the charging high-voltage power supply 21, the developing high-voltage power supply 45, a primary transfer high-voltage power supply 53, the developing device contact-and-separation unit 46, the drum cleaning device contact-and-separation unit 63, the liquid developer conveyance unit 202, a photoconductive drum drive unit 203, an intermediate transfer belt drive unit 204, and a developing roller drive unit 205 in addition to the memory 201 via an interface, not illustrated.

The developing device contact-and-separation unit 46 and the drum cleaning device contact-and-separation unit 63 are motors or operation mechanisms for turning the developing device 4 and the drum cleaning device 6 about the turning shaft 44 and the turning shaft 62, respectively.

### [Contact Control of Cleaning Blade]

In a case where the photoconductive drum 1 is rotated with the blade 61 making contact with the photoconductive drum 1, a frictional force becomes strong without a lubricant being supplied to the cleaning unit. As a result, malfunctions such as chattering, chip, and turning-up of the blade 61 occur as described above.

In general, in a case where no liquid developer is present in the cleaning unit, the frictional force is extraordinarily stronger than in the case where the liquid developer is present, and thus the above-described malfunctions easily occur. Although it depends on a liquid developer to be used, if the liquid developer, which has been supplied to the cleaning unit, is left to stand for several hours to several days, it vaporizes to become depleted due to its volatility.

In the present exemplary embodiment, a contact sequence is performed in a manner that the liquid developer is supplied to the cleaning unit where the photoconductive drum 1 and the blade 61 make contact, before the blade 61 is caused to make contact with the photoconductive drum 1. The contact sequence will be described below.

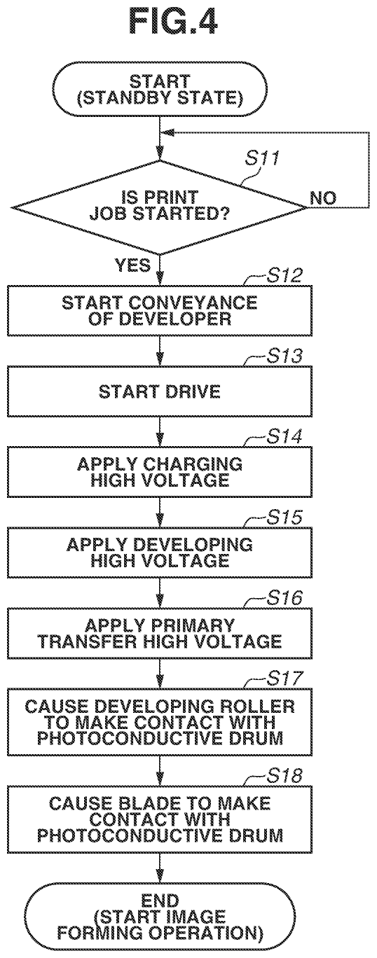

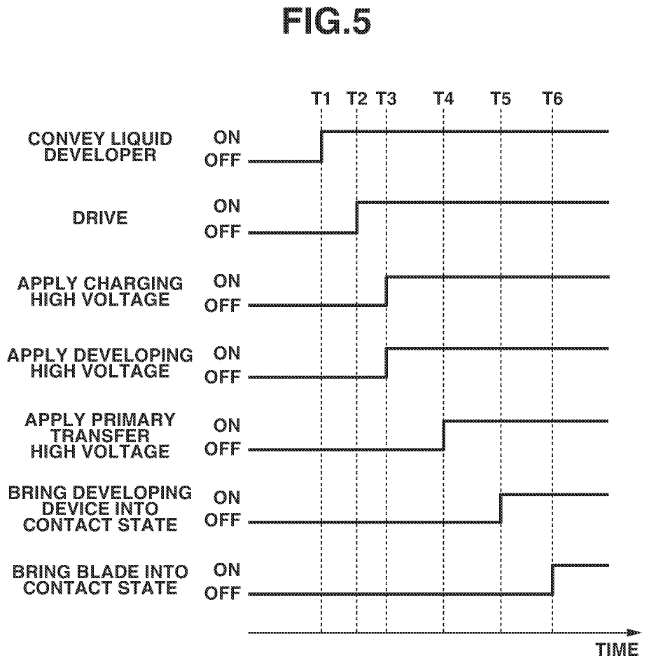

In the contact sequence, the control unit 200 performs a control flow illustrated in FIG. 4 at timing illustrated in FIG. 5. Note that the contact control is made for each of the image forming units PY to PK, but content of the control performed is the same.

A standby state before the control unit 200 receives a print signal is considered as an initial state. In this state, the pre-rotation can be started when the control unit 200 receives the print signal. At this time, the conveyance of the liquid developer is stopped, and the drive of the photoconductive drum 1, the intermediate transfer belt 51, and the developing roller 41 is stopped. Further, the developing roller 41 and the blade 61 are separated from the photoconductive drum 1, and a charging high voltage, a developing high voltage, and a primary transfer high voltage are not applied. In step S11, the print job starts when the control unit 200 receives a print signal (YES in step S11). In step S12, the liquid developer conveyance unit 202 is caused to start conveying a developer to supply the liquid developer to the developing roller 41. In step S13, the photoconductive drum drive unit 203, the intermediate transfer belt drive unit 204, and the developing roller drive unit 205 are made to drive the photoconductive drum 1, the intermediate transfer belt 51, and the developing roller 41, respectively. Note that the drive of the photoconductive drum 1, the intermediate transfer belt 51, and the developing roller 41 is started simultaneously. In steps S14 and S15, the charging high-voltage power supply 21 and the developing high-voltage power supply 45 are made to apply a charging high voltage and a developing high voltage, respectively. The charging high voltage and the developing high voltage may be applied, respectively, at any timing after the drive of the photoconductive drum 1 and the developing roller 41 is started. At this time, the exposing device 3 does not perform exposure, and the surface of the photoconductive drum 1 is charged with dark portion potential. In step S16, the primary transfer high-voltage power supply 53 is caused to apply a primary transfer high voltage at any timing after the charged portion of the photoconductive drum 1 passes through the primary transfer unit. In step S17, the developing device contact-and-separation unit 46 causes the developing roller 41 to make contact with the photoconductive drum 1 at any timing after the charged portion of the photoconductive drum 1 passes through the developing position facing the developing roller 41. Since the liquid developer is already supplied to the developing roller 41, the liquid developer is supplied to the photoconductive drum 1 simultaneously with the contact at the developing unit. At this time, the photoconductive drum 1 is charged with the dark portion potential, and the toner in the liquid developer is urged by the developing roller 41. Thus, the toner does not move to the photoconductive drum 1, but a carrier liquid is separated. That is, the developing roller 41 makes contact with the photoconductive drum 1 after a charged area, charged by the charging device 2, of the photoconductive drum 1 reaches the developing position. At this time, the carrier liquid in the liquid developer supplied to the developing unit partially moves to the photoconductive drum 1, and a residual carrier liquid remains on the developing roller 41. The carrier liquid which has moved to the photoconductive drum 1 reaches the primary transfer unit through the rotation of the photoconductive drum 1, and is separated similarly in the developing unit. That is, the carrier liquid is supplied to the intermediate transfer belt 51 in the primary transfer unit, and partially moves to the intermediate transfer belt 51. Thus, the residual carrier liquid remains on the photoconductive drum 1. Finally, in step S18, at any timing after the carrier liquid which remains on the photoconductive drum 1 reaches the cleaning position, the drum cleaning device contact-and-separation unit 63 brings the blade 61 into contact with the photoconductive drum 1. Then, the contact sequence is ended. That is, upon the start of the image forming, the control unit 200 brings the developing roller 41 into contact with the photoconductive drum 1. Before the position where the developing roller 41 makes contact with the photoconductive drum 1 (the position where supply to the photoconductive drum 1 is started, a leading end position of the carrier liquid) reaches the cleaning position, the control unit 200 causes the blade 61 to make contact with the photoconductive drum 1.

After the leading end of the carrier liquid supplied from the developing roller 41 to the photoconductive drum 1 reaches the cleaning position, the blade 61 is brought into contact with the photoconductive drum 1.

In such a manner, the contact control enables the blade 61 to be brought into contact with the photoconductive drum 1 with the liquid developer being supplied to the cleaning unit. Note that during residual pre-rotation after the contact sequence ends and during the image forming, the liquid developer is continuously supplied from the developing roller 41 to the photoconductive drum 1. The supply of the liquid developer to the photoconductive drum 1 continues until the post rotation when the developing roller 41 is separated from the photoconductive drum 1. For this reason, the supply is not interrupted until the post rotation as long as the liquid developer is supplied to the cleaning unit at timing when the blade 61 is brought into contact with the photoconductive drum 1. In the post rotation, before the supply of the liquid developer to the cleaning unit is disrupted, the blade 61 is separated so that the drive of the photoconductive drum 1 is stopped. That is, upon the end of the image forming, the control unit 200 causes the developing roller 41 to be separated. Before the position where the developing roller 41 is separated from the photoconductive drum 1 (the position where the supply to the photoconductive drum 1 is stopped, a trailing end position of the carrier liquid) reaches the cleaning position, the control unit 200 separates the blade 61 from the photoconductive drum 1. The liquid developer functions as a lubricant which reduces the frictional force between the photoconductive drum 1 and the blade 61, and can prevent degradation of image quality and productivity caused by a malfunction due to an excessive frictional force.

In order to evaluate the effects in the present exemplary embodiment, the present exemplary embodiment was compared with a comparative example without a drum cleaning device contact-and-separation unit. After the image forming apparatus was left to stand for 72 hours and then caused to do the print operation, turning-up of the blade 61 occurred in about 10 sec after the start of the rotation of the photoconductive drum in the comparative example. In contrast, the image forming apparatus 100 according to the present exemplary embodiment could stably perform the print operation. Further, even after the image forming apparatus 100 according to the present exemplary embodiment similarly executed the print operation at 100 times or more after being left to stand, malfunctions such as degradation of image quality did not occur.

As described above, the control is made so that the blade makes contact with the photoconductive drum with the liquid developer being supplied to the cleaning unit. As a result, the blade can be brought into contact with the photoconductive drum with the liquid developer which functions as a lubricant is securely present in the cleaning unit, thereby preventing degradation of image quality and productivity caused by malfunctions due to an excessive frictional force.

A second exemplary embodiment will be described. The liquid developer supplied from the developing device 4 to the photoconductive drum 1 decreases the frictional force between the photoconductive drum 1 and the blade 61 in the first exemplary embodiment. However, another means may supply the liquid developer to the cleaning unit. For example, a similar effect can be produced by disposing a supply device, which supplies a liquid developer to the photoconductive drum 1, between the primary transfer unit and the cleaning unit.

The image forming apparatus using a liquid developing method reduces degradation of cleaning performance caused by an excessive frictional force between the cleaning blade and the photoconductive drum at the start of image forming.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2018-216858, filed Nov. 19, 2018, which is hereby incorporated by reference herein in its entirety.

What is claimed is:

1. An image forming apparatus comprising:
a photoconductive drum on which a latent image is to be formed;
a developing device configured to develop the latent image to be formed on the photoconductive drum into a toner image, the developing device including,
a developing roller configured to hold a liquid developer containing toner and a carrier liquid, the developing roller being disposed to be movable to a first contact position where the developing roller makes contact with the photoconductive drum and a first separation position where the developing roller is separated from the photoconductive drum;
a first motor configured to move the developing roller to the first contact position and the first separation position;
a blade configured to clean the photoconductive drum, the blade being disposed to be movable to a second contact position where the blade makes contact with the photoconductive drum and a second separation position where the blade is separated from the photoconductive drum;
a second motor configured to move the blade to the second contact position and the second separation position; and
a control unit configured to control the first motor and the second motor,
wherein the control unit controls the first motor and the second motor so that the developing roller is moved from the first separation position to the first contact position upon start of image forming, and a blade is moved from the second separation position to the second contact position after a position of the photoconductive drum where the developing roller starts contacting reaches a cleaning position opposing the blade.

2. The image forming apparatus according to claim 1, wherein the control unit controls the first motor so that the developing roller is moved from the first separation position to the first contact position upon the start of the image forming, and the developing roller is moved from the first contact position to the first separation position upon end of the image forming.

3. The image forming apparatus according to claim 1, wherein the control unit controls the second motor so that the blade is moved from the second separation position to the second contact position upon the start of the image forming, and the blade is moved from the second contact position to the second separation position upon end of the image forming.

4. The image forming apparatus according to claim 1, wherein the developing roller is a rubber roller.

5. The image forming apparatus according to claim 1, further comprising:
a charging device configured to charge the photoconductive drum,
wherein the control unit controls the first motor so that the developing roller is moved from the first separation position to the first contact position after an area of the photoconductive drum charged by the charging device passes through a developing position facing the developing roller.

6. The image forming apparatus according to claim 1, further comprising:
a drive motor configured to rotate the developing roller,
wherein the control unit controls the first motor so that the developing roller is moved from the first separation position to the first contact position after drive of the developing roller is started upon the start of the image forming.

7. The image forming apparatus according to claim 1, further comprising:
a power supply configured to apply a voltage to the developing roller,
wherein the control unit controls the first motor so that the developing roller is moved from the first separation position to the first contact position after the voltage is applied to the developing roller upon the start of the image forming.
